(19) United States
(12) Patent Application Publication
(10) Pub. No.: US 2004/0079613 A1
(43) Pub. Date: Apr. 29, 2004

(54) Shift lock device for a shift lever in an automatic transmission

(76) Inventor: Yang-Rae Cho, Gyeonggi-do (KR)

Correspondence Address: MORGAN, LEWIS & BOCKIUS, LLP., 3300 HILLVIEW AVENUE, PALO ALTO, CA, 94304, US

(21) Appl. No.: 10/621,912

(22) Filed: Jul. 17, 2003

(30) Foreign Application Priority Data
Oct. 24, 2002 (KR) 2002-65223

(51) Int. Cl. B60K 41/26

(52) U.S. Cl. 192/220.7

(57) ABSTRACT

A shift lock device for a shift lever of an automatic transmission, wherein the manipulation or non-manipulation of a brake pedal by a driver is received in the form of an electrical signal to prompt a solenoid actuator to rotate a single rotating cam and to perform a P range shift lock function and a shift lock function from the N range to the R range in a simple structure, such that the conventional cumbersome mounting operation of a shift cable can be eliminated and a simple manipulation of a brake pedal enables a smooth and secured release of the shift lock, thereby improving the convenience of a vehicle.

### FIELD OF THE INVENTION

The present invention relates to a shift lock device for a shift lever in an automatic transmission and, more particularly, to a shift lock device for a gate type transmission.

### BACKGROUND OF THE INVENTION

Conventionally, shift lock devices are designed to prevent various safety-related accidents when a novice driver or a driver less accustomed to an automatic transmission-mounted vehicle manipulates the shift lever to start a vehicle when the driver suddenly depresses on the accelerator pedal without the brake pedal being depressed. The shift lock device is engaged when a vehicle is parked to avoid operation of a shift lever. The shift lock device is released by an ignition switch when the driver depresses the brake pedal after a vehicle is started and in motion, thereby enabling the driver to operate the shift lever.

Shift lock devices typically include a shift lock cable connected to a brake pedal and a shift lock cam connected to the shift lock cable, such that it is impossible to operate a shift lever unless a driver depresses the brake pedal. There are drawbacks with such devices, for example, in that they can be comparatively cumbersome and complicated to mount a shift lock cable for transmitting a manipulative power of a brake pedal to a shift lock cam, thereby decreasing the efficiency of the manufacturing process. There is another drawback in that the brake pedal typically must be deeply depressed to properly release the shift lock due to ineffective stroke inevitably generated in terms of the structure of the shift lock cable, thereby deteriorating the convenience of the operation.

The positions of the shift lever in a gate type shifting device of an automatic transmission can be easily identified without the driver having to perform visual checks and a shift knob button may be eliminated to increase convenience. The shift lever is constructed to move along two or three linear paths which meet perpendicularly whenever each range is changed, thereby allowing a driver to distinguish each shift range.

### SUMMARY OF THE INVENTION

Embodiments of the present invention may be applied to a gate type shifting device of an automatic transmission thus described to solve the complicated assembly procedure resulting from a mounted shift lock cable and to smoothly disengage a shift lock with a simple brake pedal manipulation, thereby improving the convenience of the operation.

In accordance with a preferred embodiment of the present invention, a shift lock device for a shift lever of an automatic transmission comprises a gate structure wherein a range is set up in the order of P, R, N and D. In order to move a shift lever from the P and N ranges to the R range, the shift lever is initially moved in a lateral direction from the P and N ranges and then perpendicularly moved toward the R range. The shift lever device preferably comprises a cam body integrally mounted to the shift lever, a rotating cam configured to act on the cam body to prevent the shift lever from moving laterally from the P and N ranges, a brake pedal switch and rotating means for rotating the rotating cam in response to an electric signal of the brake pedal switch.

In another embodiment of the invention, a shift lock device comprises a cam body on which a shift lever is mounted. A rotating cam cooperates with the cam body to selectively block lateral movement of the cam body. A linkage mechanism cooperates with the rotating cam to rotate the rotating cam in response to a lock release signal. The shift lever lock device further comprises a brake switch activated by depression of a brake pedal to generate the lock release signal. The linkage mechanism comprises a solenoid with an actuating rod actuated in response to the signal. A pivotably mounted link member has one end that acts on the rotating cam and an opposite end that is acted on by the actuating rod. The shift lock device further comprises an emergency lever cooperating with the rotating cam to rotate the cam in the absence of the lock release signal.

### BRIEF DESCRIPTION OF THE DRAWINGS

For a fuller understanding of the nature and objects of the present invention, reference should be made to the following detailed description taken in conjunction with the accompanying drawings in which:

FIG. 1 is a perspective view illustrating an exterior of a shift lock device for a shift lever according to an embodiment of the present invention;

FIGS. 2 and 3 are schematic assembly drawings of a shift lock device for a shift lever according to an embodiment of the present invention;

FIGS. 4 and 5 are schematic drawings illustrating an operation of a shift lock at the P range;

FIGS. 6 and 7 are schematic drawings illustrating a shift lock disengaged at the P range;

FIG. 8 is a schematic drawing illustrating an operation of a shift lock from the N range to the R range;

FIGS. 9 and 10 are schematic drawings illustrating a shift lock disengaged from the N range to the R range; and

FIGS. 11 and 12 are schematic drawings for illustrating a state of a shift lock being manually released.

### DETAILED DESCRIPTION OF THE INVENTION

Hereinafter, the preferred embodiment of the present invention will be described in detail with reference to the accompanying drawings.

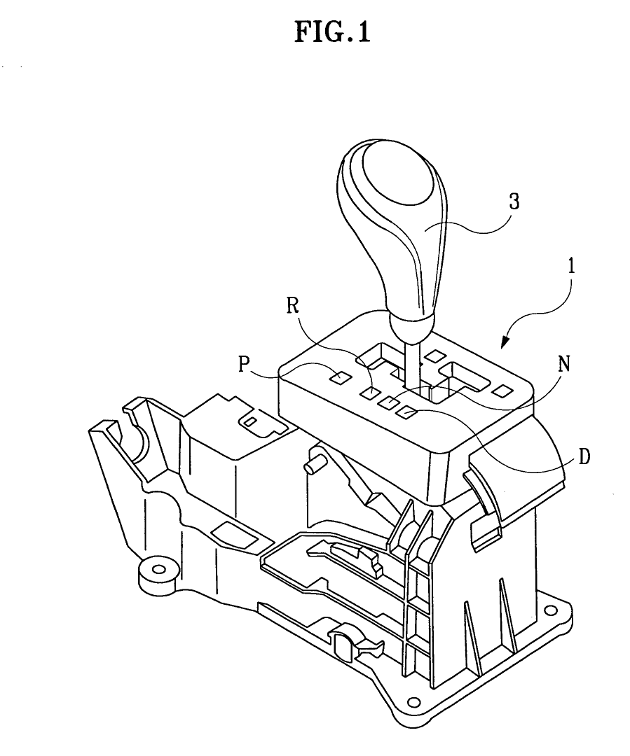

A gate type shifting device of an automatic transmission, as shown in a gate bracket 1 in FIG. 1, is configured with a range in the order of P, R, N and D. In order to move a shift lever 3 from the P and N ranges to the R range, the shift lever 3 is initially laterally moved from the P and N ranges and then the shift lever 3 is linearly moved in a perpendicular direction toward the R range. A gate is mounted at the right side of the D range for manually increasing and decreasing the speed of the vehicle.

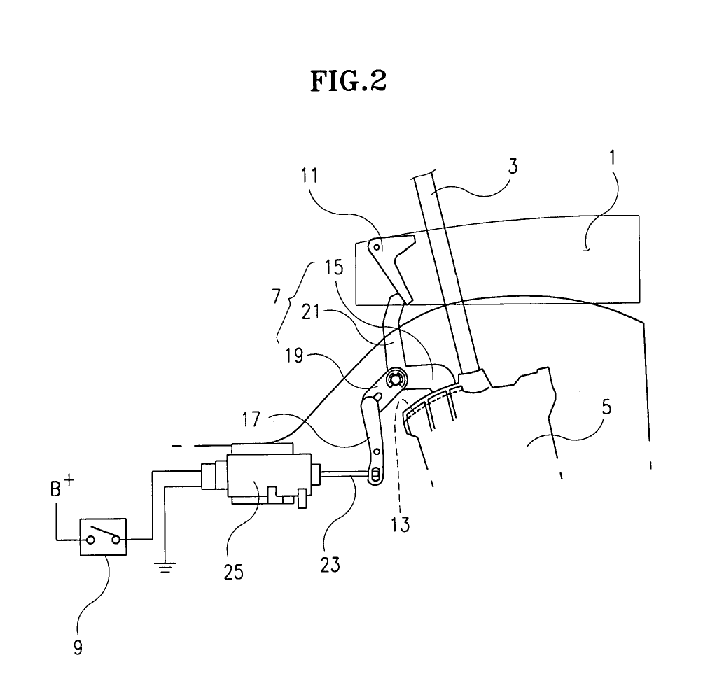

As shown in FIG. 2, a preferred embodiment of the present invention includes a cam body 5 integrally mounted to the shift lever 3. A rotating cam 7 is configured to act on the cam body 5 to restrain the shift lever 3 from moving in a lateral direction from the P and N ranges. Rotating means rotate the rotating cam 7 in response to an electric signal of a brake pedal switch 9. An emergency lever 11 is mounted to rotate the rotating cam 7 by way of a driver's manipulating power.

As explained above, the shift lever 3 is initially shifted in a lateral direction for engagement from the P range to another range. Engagement or disengagement of the shift lever 3 is controlled by the cam body 5 and the rotating cam 7. Furthermore, when the shift lever 3 is in the N range, it is also initially moved in a lateral direction for engagement to the R range, and engagement or disengagement of the shift lever 3 at this stage is also controlled by the cam body 5 and the rotating cam 7.

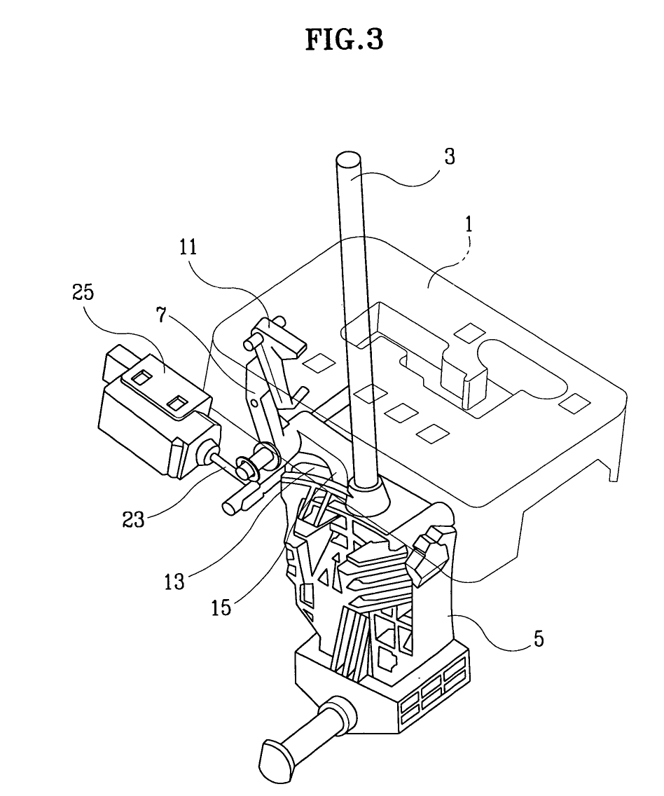

Hereinafter, the construction of the cam body 5 and the rotating cam 7, and the rotating means for rotating the rotating cam 7 will be further described in detail with respect to FIGS. 2 and 3.

The cam body 5 is disposed with a cam wall 13 formed in parallel with a rotating plane of the rotating cam acting with the rotating cam 7. The rotating cam 7 includes a locking arm 15 acting on the cam body 5, a link arm 19 connected to a link 17 of the rotating means and a lever arm 21 connected to the emergency lever 11. In one embodiment the rotating means may include a solenoid actuator 25 having an actuating rod 23 for linear movement in response to an electrical signal from the brake pedal switch 9 according to brake pedal manipulation by a driver. Link 17 connects the actuating rod 23 to the link arm 19 of the rotating cam 7 to change the linear movement of the actuating rod 23 to a rotating movement of the rotating cam 7.

The solenoid actuator 25 pulls the actuating rod 23 when a driver depresses the brake pedal to activate the brake pedal switch 9, and the link 17 connected to the actuating rod 23 is rotated clockwise as shown in FIG. 3 so that the rotating cam 7 is rotated counterclockwise. Meanwhile, the emergency lever 11 is projected upwards from the gate bracket 1 to be rotated in response to a driver's push and the rotating cam 7 is rotated counterclockwise.

Hereinafter, the operation of the shift lock device of the shift lever thus constructed will be described.

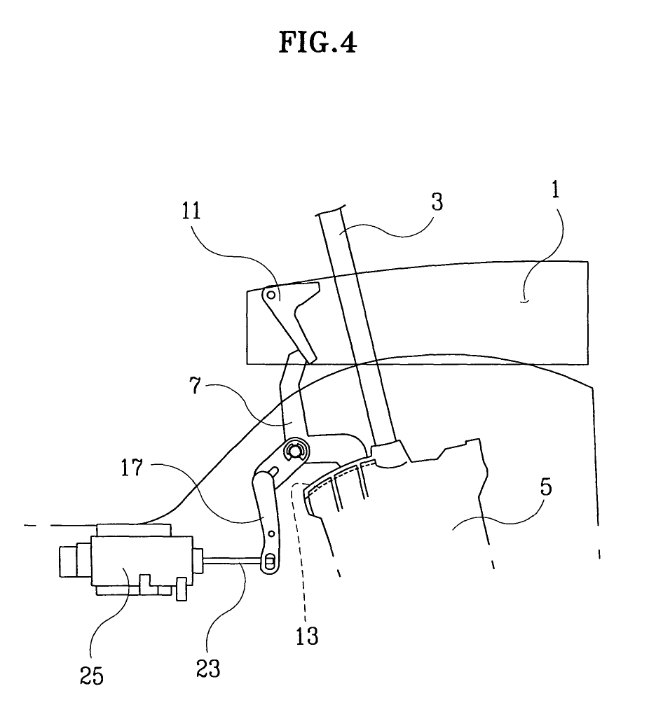

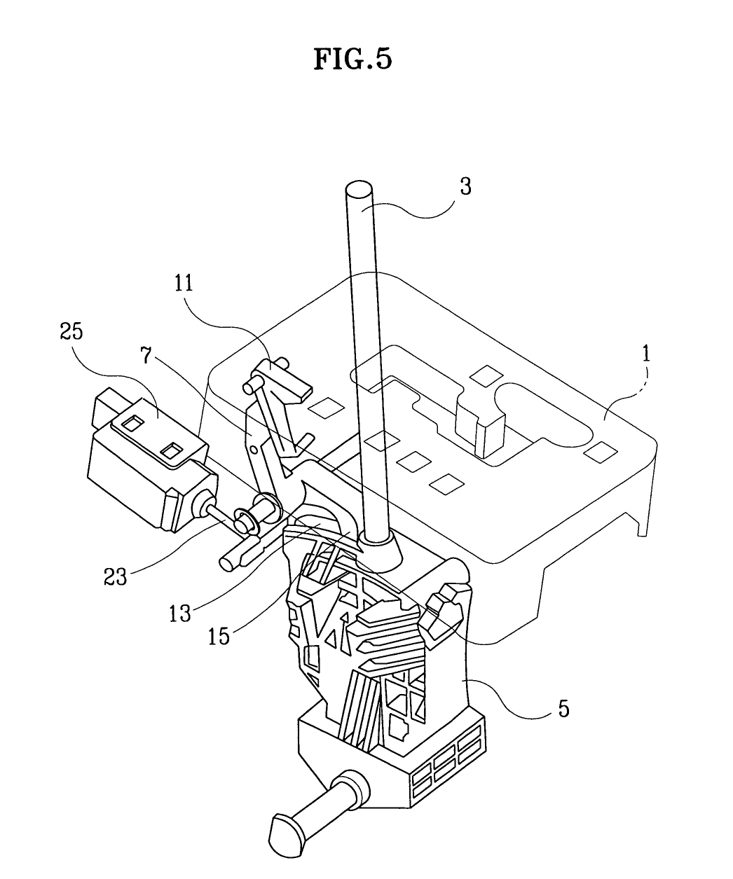

With reference to FIGS. 4 and 5, which describe the operation of the shift lock at P range, the shift lever is first laterally moved in order to shift out of the P range. This is a state where the locking arm at the rotating cam blocks a cam wall of the cam body to restrain the shift lever from moving and is also a state where the shift locking function is performed.

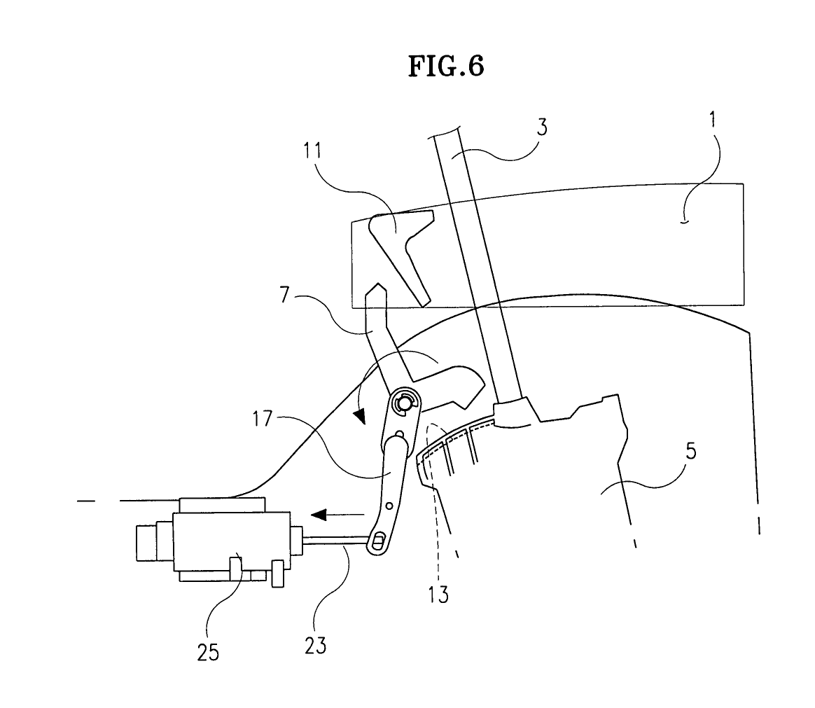

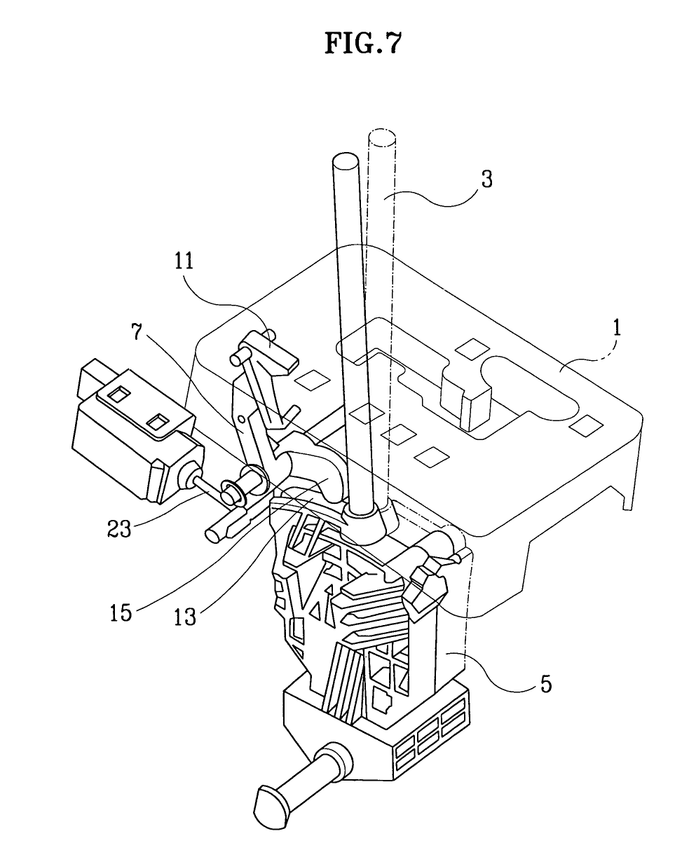

In order to disengage the shift locking under the P range state, the driver depresses the brake pedal. When the driver depresses the brake pedal, the brake pedal switch is actuated to supply power to the solenoid actuator, thereby pullin the actuating rod. When the actuating rod is pulled, the link is rotated clockwise to rotate the rotating cam counterclockwise, and as illustrated in FIGS. 6 and 7, the locking arm at the rotating cam can fully escape from a moving route of the cam wall at the cam body. As a result, the shift lock becomes disengaged under the above state, whereby a driver can move the shift lever laterally and then in a perpendicular direction, thereby enabling the shift lever to shift to other ranges.

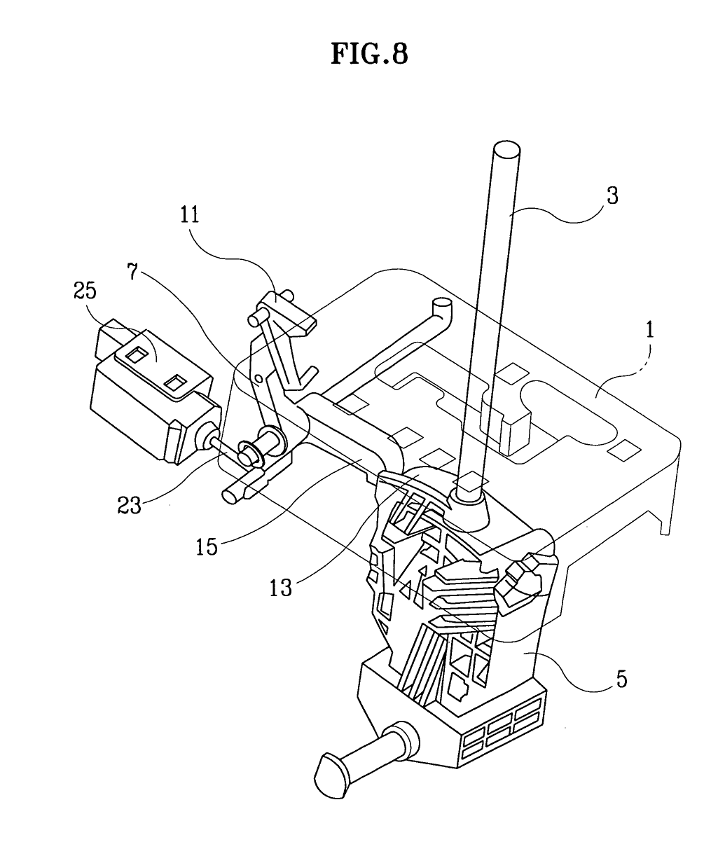

FIG. 8 illustrates a state where the shift lever is restrained from being shifted to the R range while positioned in the N range. It should be noted that the locking arm of the rotating cam is restrained from moving laterally in the cam wall at the cam body. As a result, a driver cannot move the shift lever laterally and then in a perpendicular direction to change same to the R range while the brake pedal is not depressed when a vehicle is in motion.

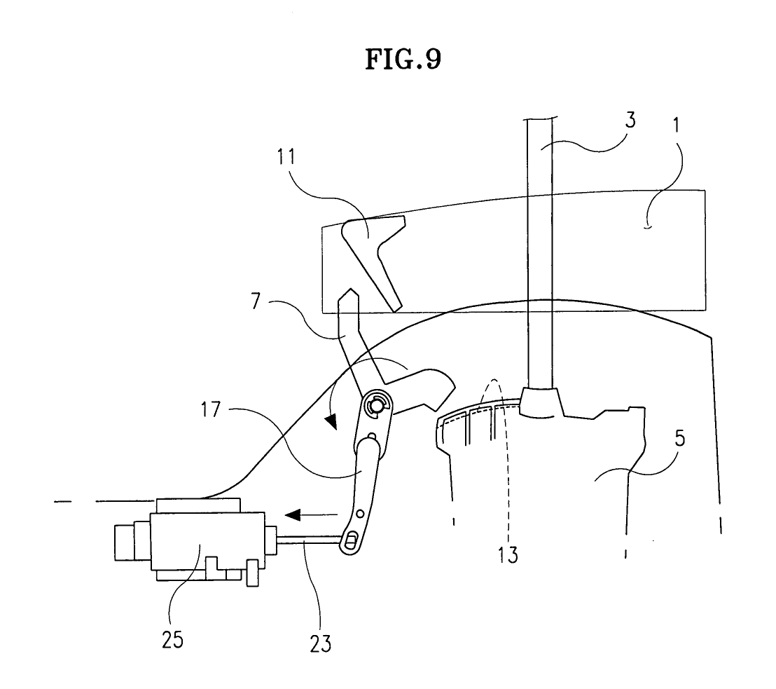

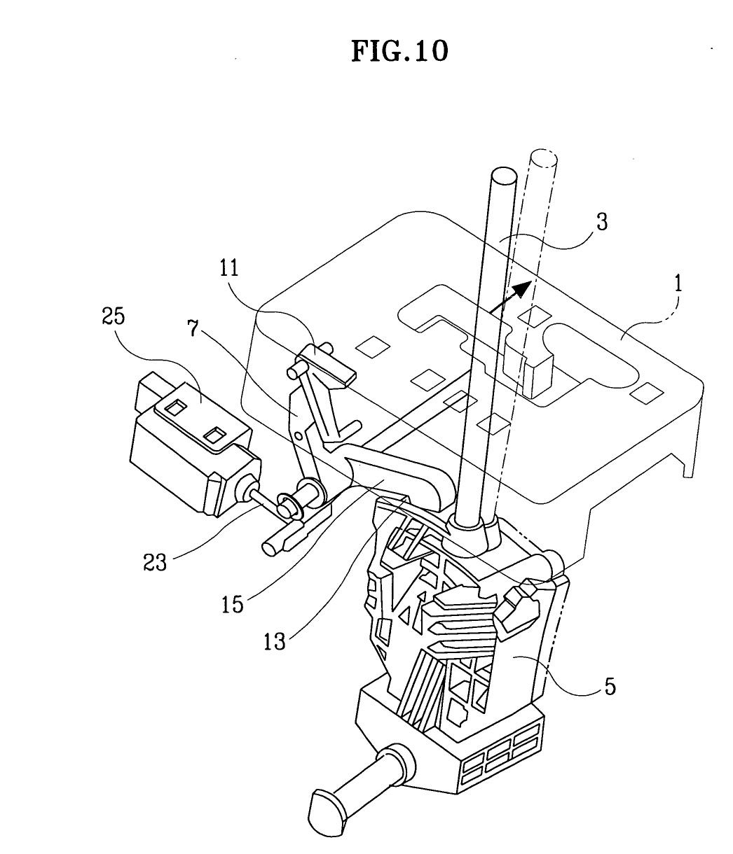

Of course, when a driver depresses the brake pedal, power is supplied to the solenoid actuator by the brake pedal switch, and the actuating rod rotates the link clockwise as shown in FIG. 9 to rotate the rotating cam counterclockwise. Thereafter, the locking arm frees the moving route of the cam body, whereby the driver moves the shift lever laterally to position same to the R range as illustrated in FIG. 10.

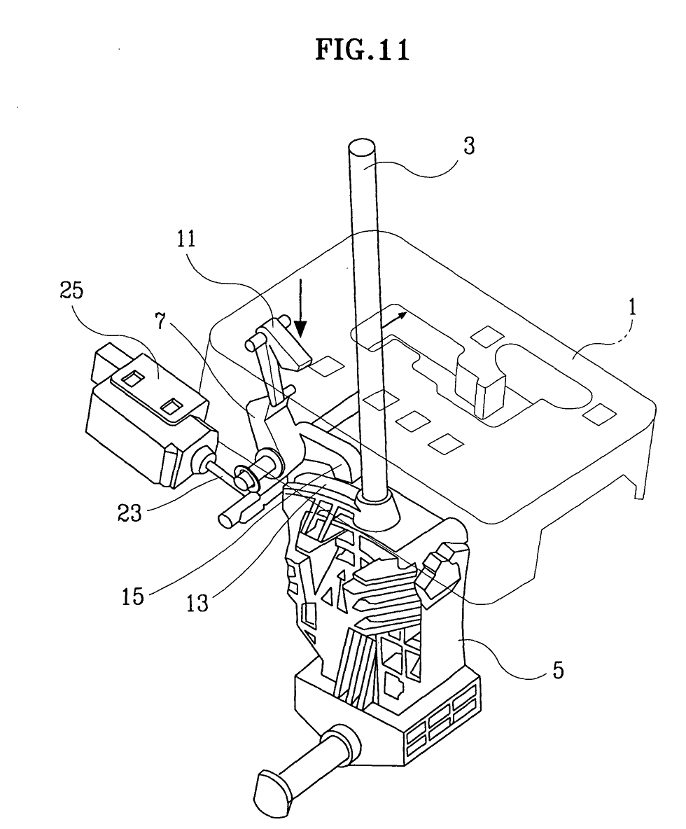

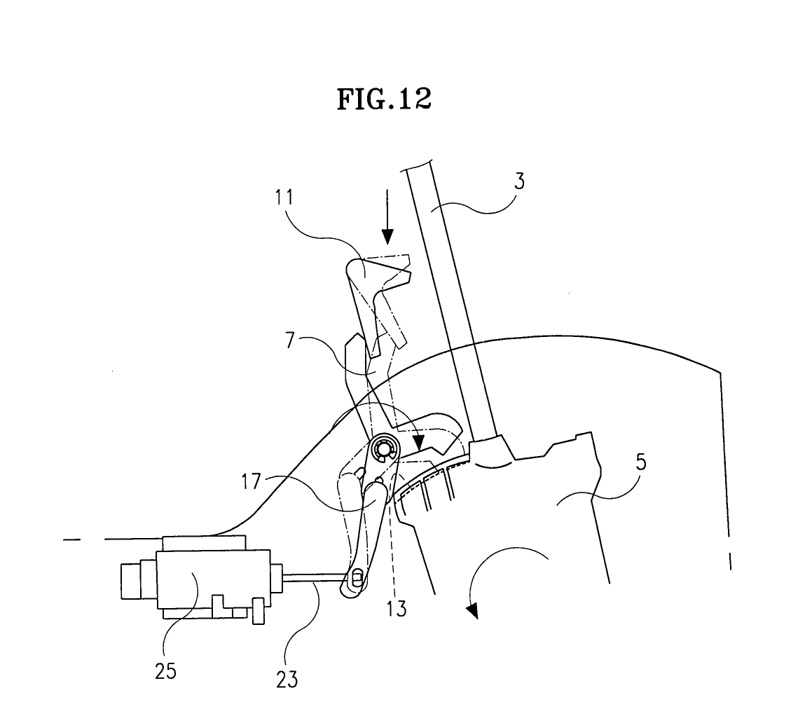

Meanwhile, the shift lock device determines whether or not a brake pedal is depressed by the brake pedal switch, and its operation is realized by an electromagnetic working of the solenoid actuator. In case there occurs an electric problem such as a discharge of a battery or the like, or when there is a need to park a vehicle at the N range, there is equipped an emergency lever. When an emergency lever is depressed by a driver as shown in FIG. 11, the emergency lever is rotated clockwise as illustrated in FIG. 12 to push a lever arm at the rotating cam. The rotating cam is then rotated counterclockwise to disengage the shift lock because the travel path of the cam wall at the cam body is not interfered.

As apparent from the foregoing, there is an advantage in the shift lock device for a shift lever of an automatic transmission thus described in that manipulation or non-manipulation of a brake pedal by a driver is received in the form of an electrical signal to prompt a solenoid actuator to rotate a single rotating cam and to perform a P range shift lock function and a shift lock function from the N range to the R range in a simple structure, such that the conventional cumbersome mounting operation of a shift cable can be eliminated, and a simple manipulation of a brake pedal enables a smooth and secured release of the shift lock, thereby improving the convenience of a vehicle.

What is claimed is:

1. A shift lock device for a shift lever of an automatic transmission, the transmission having a gate structure wherein a range is set up in the order of P, R, N and D, and in order to move a shift lever from the P and N ranges to the R range, said shift lever is moved in a lateral direction, respectively, and then moved perpendicularly toward the intended range, wherein said shift lever device comprises: a cam body integrally mounted to said shift lever; a rotating cam configured to act on said cam body to prevent said shift lever from moving in lateral direction from either the P or N range; a brake pedal switch; and rotating means for rotating said rotating cam in response to an electric signal of said brake pedal switch.

2. The device as defined in claim 1, wherein said cam body is disposed with a cam wall formed in parallel with a rotating plane of said rotating cam acting with said rotating cam.

3. The device as defined in claim 1, wherein said rotating means comprises: a solenoid actuator having an actuating rod for linear movement in response to an electrical signal from a brake pedal switch according to a brake pedal manipulation by a driver; and a link for connecting an actuating rod to a link arm of said rotating cam to change a linear movement of said actuating rod to a rotating movement of said rotating cam.

4. The device as defined in claim 1 further comprising an emergency lever for rotating said rotating cam in response to the manipulating power of a driver.

5. The device as defined in claim 4, wherein said rotating cam comprises: a locking arm acting on said cam body; a link arm connected to said rotating means; and a lever arm connected to said emergency lever.

6. A shift lock device, comprising:
a cam body on which a shift lever is mounted;
a rotating cam cooperating with said cam body to selectively block lateral movement of said cam body;
a linkage mechanism cooperating with said rotating cam to rotate said rotating cam in response to a lock release signal.

7. The shift lever lock device of claim 6, further comprising a brake switch activated by depression of a brake pedal to generate said lock release signal.

8. The shift lever of claim 7, wherein said linkage mechanism comprises:
a solenoid with an actuating rod actuated in response to said signal; and
a pivotably mounted link member having one end acting on said rotating cam and an opposite end acted on by said actuating rod.

9. The shift lock device of claim 6, further comprising an emergency lever cooperating with said rotating cam to rotate said cam in the absence of said lock release signal.
